(19) United States
(12) Patent Application Publication
(10) Pub. No.: US 2018/0362214 A1
(43) Pub. Date: Dec. 20, 2018

(54) LINER WITH ANTI-MICROBIAL AND/OR ANTI-FUNGAL AGENT

(71) Applicants: Steve Kohn, Short Hills, NJ (US); Amy Rigazio, Farmingdale, NJ (US)

(72) Inventors: Steve Kohn, Short Hills, NJ (US); Amy Rigazio, Farmingdale, NJ (US)

(21) Appl. No.: 15/622,649

(22) Filed: Jun. 14, 2017

(51) Int. Cl. B65D 25/16; A01N 25/34

(52) U.S. Cl. CPC B65D 25/16; A01N 25/34

(57) ABSTRACT

A liner comprising polyethylene, polypropylene, or another polyolefin plastic or any combination of same. The liner is placed on a surface. The liner is comprised of material that protects objects placed on the liner from microbes, fungus, mold, mildew and moisture that are found on the surface on which the liner is placed.

### FIELD OF THE INVENTION

The present invention relates to a liner that is used to protect objects that are placed on top of the liner.

### BACKGROUND OF THE INVENTION

When storing items or furniture, most items are first placed in boxes or in the case of furniture, may be placed directly on an un-protected or un-covered surface. The surface may contain microbes, mold, mildew and/or moisture which could affect the integrity of the boxes, thereby harming the contents of the boxes or the furniture.

### SUMMARY OF THE INVENTION

The present invention relates to a liner that is placed on a surface to protect the objects placed on it from microbes, mold, mildew, and/or moisture which could be found on the surface. It is an object of the present invention to add an antimicrobial and/or anti-fungal compound to a liner to inhibit the growth of mold and mildew.

It is an object of the present invention for the liner to create a clean, dry surface on which boxes, objects, furniture and other items may be stacked.

It is an object of the present invention for the liner to provide barrier protection from moisture.

It is an object of the present invention for the width of an individual liner to be approximately two inches to 60 feet.

It is an object of the present invention for the length of an individual liner to be two inches to 60 feet.

It is an object of the present invention for the liner to be manufactured and/or sold in rolls of film and/or individual pieces. It is an object of the present invention for the roils of liner to have perforations to allow the roll to be easily separated into individual pieces for use and/or resale.

It is an object of the present invention for the thickness of the liner to be 0.5 millimeter to 10.0 millimeter thick.

It is an object of the present invention for the liner to be treated with a non-slip additive.

It is an object of the present invention for the liner to be treated with a no-slip additive.

It is an object of the present invention for the liner to comprise a no-slip resin and/or a no-slip additive.

It is an object of the present invention for the liner to comprise a non-slip resin and/or a non-slip additive.

It is an object of the present invention that the liner is comprised of polyethylene, polypropylene or another polyolefin plastic.

It is an object of the present invention for the liner to comprise LLDPE, LDPE, HDPE resin or any combination of same.

It is an object of the present invention for the liner to comprise reprocessed resin.

It is an object of the present invention for the liner to comprise reprocessed resin, no slip resin or non-sap resin, or any combination of same.

It is an object of the present invention for the liner to comprise polyethylene, polypropylene, another polyolefin plastic, reprocessed resin, no slip resin, non-slip resin, no slip additive and non-slip additive, or any combination of same.

It is an object of the present invention for the liner to comprise a material without reprocessed resin to control the slip factor or static electricity properties of the liner.

It is an object of the present invention for the liner to be reusable.

It is an object of the present invention for the liner to be washable.

It is an object of the present invention for the liner to be washable in a washing machine.

It is an object of the present invention for the liner to provide protection to objects placed on top of the liner whether the liner is used indoors or outdoors.

It is an object of the present invention for the liner to be used in temperatures ranging from approximately −50 degrees Fahrenheit to 150 degrees Fahrenheit, regardless of any wind chill factors.

It is an object of the present invention for the liner to be used in places such as storage units, self-storage units, portable storage containers or moving containers, garages, cellars, basements, attics, truck beds, tractor trailer beds, flatbed trucks, recreational vehicles, SUV's, camping grounds and trailer parks.

It is an object of the present invention for the liner to be placed on surfaces such as grass, dirt and sand.

It is an object of the present invention for the liner to be placed on surfaces made from materials such as concrete, polyurethane, tile, wood, stone, straw and glass.

It is an object of the present invention for the liner to further comprise an attachment mechanism for attaching the device to a surface. It is an object of the present invention for the attachment mechanism to comprise an adhesive.

It is an object of the present invention for the liner to further comprise an attachment mechanism for attaching the device to a surface such as grass, dirt or sand. It is an object of the present invention for the attaching device to comprise an object such as a stake that enters the grass, dirt or sand. It is an object of the present invention for the attaching device to hold the liner to the grass, dirt or sand surface. It is an object of the present invention for the liner to have one, several, or many holes with or without grommets or other devices for hole reinforcement through which the attaching device may be placed.

It is an object of the present invention for the anti-fungal and anti-microbial agents to contain one or more of copper (II) 8-quinolinolate (CAS No. 10380-28-6); zinc oxide (CAS No. 1314-13-2); zinc-dimethyl dithiocarbamate (CAS No. 137-304); 2-mercaptobenzothiazole, zinc salt (CAS No. 155-04-4); barium metaborate (CAS No. 13701-59-2); tributyl tin benzoate (CAS No. 4342-36-3); bis tributyl tin salicylate (CAS No. 22330-14-9); tributyl tin oxide (CAS No. 56-35-9); parabens: ethyl parahydroxybenzoate (CAS No. 120-47-8); propyl parahydroxybenzoate (CAS No. 94-13-3); methyl parahydroxybenzoate (CAS No. 99-76-3); and butyl parahydroxybenzoate (CAS No. 94-26-8); methylenebis(thiocyanate) (CAS No. 6317-18-6); 1,2-benzisothiazoline-3-one (CAS No. 2634-33-5); 2-mercaptobenzo-thiazole (CAS No. 149-30-4); 5-chloro-2-methyl-3 (2H)-isothiazolone (CAS No. 57373-19-0); 2-methyl-3(2H)-isothiazolone (CAS No. 57373-20-3); zinc 2-pyridinethiol-N-oxide (CAS No. 1346341-7); tetra-hydro-3,5-di-methyl-2H-1,3,5-thiadiazine-2-thione (CAS No. 533-74-4); N-trichloromethyl-thio-4-cyclohexene-1,2-dicarboximide (CAS No. 133-06-2); 2-n-octyl-4-isothiazoline-3-one (CAS No. 26530-20-1); 2,4,5,6-tetrachloro-isophtalonitrile (CAS No. 1897-45-6); 3-iodo-2-propynyl butylcarbamate (CAS No. 55406-53-6); diiodomethyl-p-tolylsulfone (CAS No. 20018-09-1); N-(trichloromethyl-thio)phthalimide (CAS No. 133-07-3); potassium N-hydroxy-methyl-N-methyl-dithiocarbamate (CAS No. 51026-28-9); sodium 2-pyridinethiol-1-oxide (CAS No. 15922-78-8); 2-(thiocyanomethylthio) benzothiazole (CAS No. 21564-17-0); 2-4(-thiazolyl)benzimidazole (CAS No. 148-79-8).

It is an object of the present for the anti-microbial agents and/or anti-fungal agents to be mixed with the resins in a suitable concentration and extruded on a blown or cast film extruder.

It is an object of the present for the anti-microbial agents and/or anti-fungal agents to be applied to the liner in a suitable concentration after the liner is extruded on a blown or cast film extruder.

It is an object of the present invention for the liner to protect goods placed on the liner from molds and fungi by acting as a barrier to stop mold or fungi from getting onto the bottom of the goods.

It is an object of the present invention for the liner to comprise a flexible, semi-rigid or rigid plastic.

It is an object of the present invention that the liner comprises a blend of plastic resins that include recycled plastic.

It is an object of the present invention that the liner conforms to the surface on which it is placed.

It is an object of the present invention that the liner has printing on its surface.

It is an object of the present invention that the liner comprise logos, such as corporate logs to provide messages such as brand reinforcement. It is an object of the present invention that the liner has a printed series of repeating logos such as corporate logos.

It is an object of the present invention that the liner be used as an advertising vehicle to communicate messages, coupons or contests to customers.

It is an object of the present invention that the liner contains a fragrance.

It is an object of the present invention that the liner contains an odor-neutralizing agent.

It is an object of the present invention for the liner to be transparent. It is an object of the present invention for the liner to be translucent. It is an object of the present invention for the liner to be opaque. It is an object of the present invention for the liner to have color such as from tinted resins.

### BRIEF DESCRIPTION OF DRAWINGS

FIG. 1 is a front view of an embodiment of the present invention used outdoors.

FIG. 2 is a front view of an embodiment of the present invention used in a housing setting.

FIG. 3 is a front view of an embodiment of the present invention used in a storage unit.

FIG. 4 is a front view of an embodiment of the present invention used on a truck bed.

FIG. 5 shows a front view of an embodiment of the present invention.

FIG. 6 shows a front view of an embodiment of the present invention.

FIG. 7 shows a front view of an embodiment of the present invention.

### DETAILED DESCRIPTION OF THE INVENTION

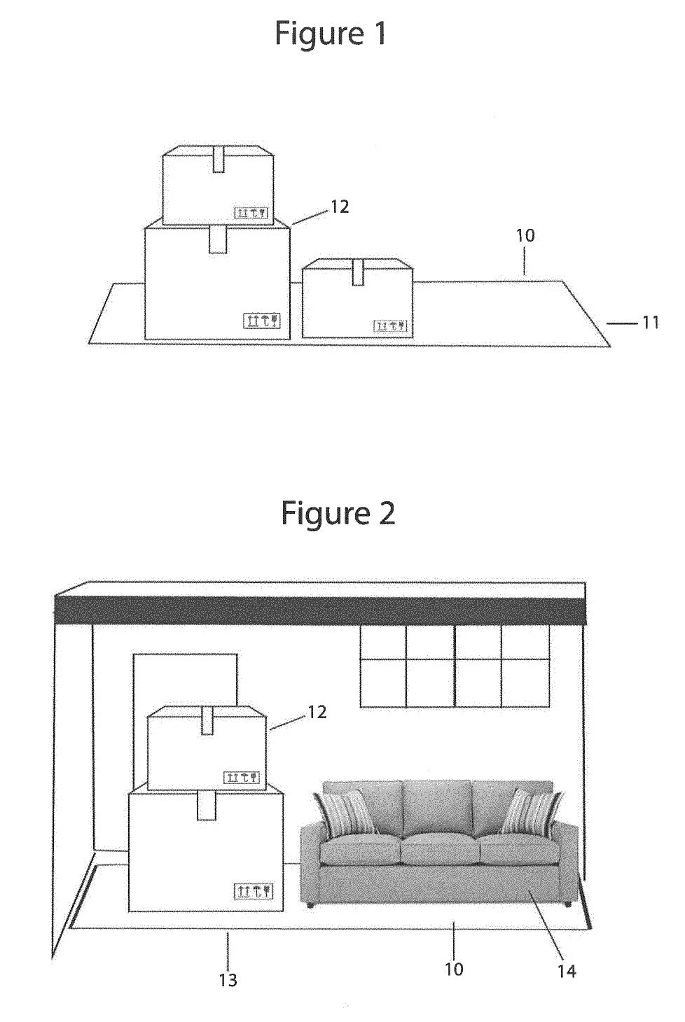

FIG. 1 shows a liner 10 placed on the ground 11 having boxes 12 stacked on top of the liner 10. The liner 10 is placed on the ground 11 and protects the boxes 12 from microbes, mold, and mildew when an antimicrobial compound is part of the liner 10, and provides a moisture barrier to moisture found on the surface of the ground 11, The liner 10 creates a dean, dry surface on which boxes 12, and other objects may be stacked.

FIG. 2 shows a liner 10 placed on the floor 13 of a dwelling having boxes 12 stacked on the liner 10, and furniture 14 placed on top of the liner 10. The liner 10 is placed on the floor 13 and protects the boxes 12 and furniture 14 from microbes, mold, and mildew when an antimicrobial compound is part of the liner 10, and also provides a moisture barrier to moisture found on the surface of the floor 13, The liner 10 creates a clean, dry surface on which boxes 12, furniture 14, and other objects may be stacked or placed.

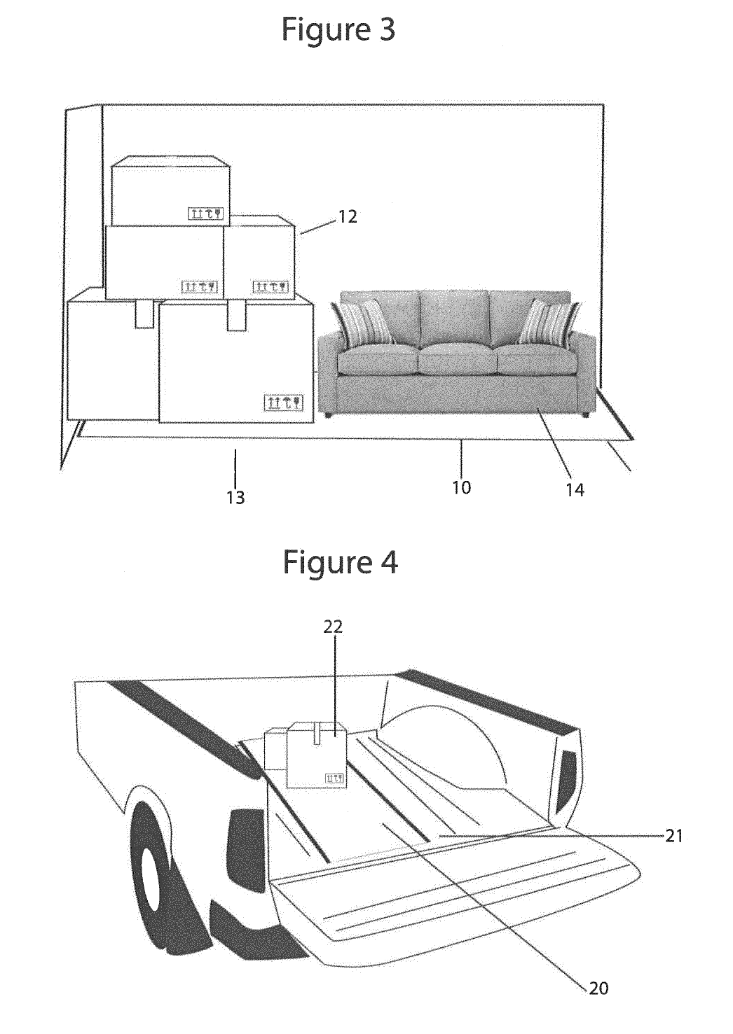

FIG. 3 shows a liner 10 placed on the floor 13 of a storage unit having boxes 12 stacked on the liner 10, and furniture 14 placed on top of the liner 10. The liner 10 is placed on the floor 13 and protects the boxes 12 and furniture 14 from microbes, mold, and mildew when an antimicrobial compound is part of the liner 10, and also provides a moisture barrier to moisture found on the surface of the floor 13. The liner 10 creates a clean, dry surface on which boxes 12, furniture 14, and other objects may be stacked. The liner 10 provides barrier protection from moisture.

FIG. 4 shows a liner 20 placed on the bottom 21 of a truck bed having boxes 22 stacked on the liner 20. The liner 20 is placed on the bottom 21 and protects the boxes 22 from microbes, mold, and mildew when an antimicrobial compound is part of the liner 20, and provides a moisture barrier to moisture found on the surface of the bottom 21. The liner 20 creates a dean, dry surface on which boxes 22, and other objects may be stacked.

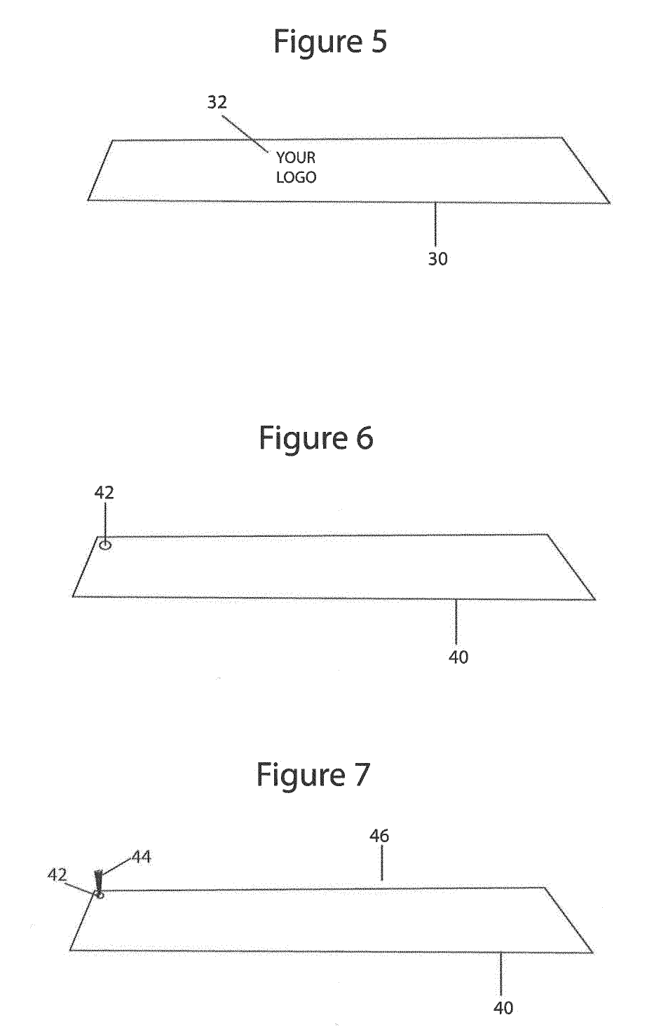

FIG. 5 shows a liner 30 having a logo 32 on the surface of the liner.

FIG. 6 shows a liner 40 having a hole reinforced with a grommet 42.

FIG. 7 shows a liner 40 having a hole reinforced with a grommet 42 having a stake 44 going through the grommet 42 into the ground 46.

1. A liner comprising:
a liner comprised of polyethylene, polypropylene, or another polyolefin plastic or any combination of same;
said liner placed on a surface;
said liner comprising a material that protects objects placed on said liner from microbes, fungus, mold, mildew, and moisture that are found on the surface that said liner is placed on.

2. The liner of claim 1 further comprising an antimicrobial and/or anti-fungal compound to inhibit growth of mold and mildew.

3. The liner of claim 1 wherein said liner creates a clean, dry surface on which boxes, objects, furniture and other items may be stacked.

4. The liner of claim 1 wherein said liner provides barrier protection from moisture for said objects.

5. The liner of claim 1 wherein width of an individual liner is approximately two inches to 60 feet.

6. The liner of claim 1 wherein length of an individual liner is two inches to 60 feet.

7. The liner of claim 1 wherein said liner is manufactured and/or sold in rolls of film and/or individual pieces.

8. The liner of claim 7 wherein said rolls of liner have perforations to allow said roll to be separated into individual pieces for use.

9. The liner of claim 1 wherein said liner has a thickness of 0.5 millimeter to 10.0 millimeter thick.

10. The liner of claim 1 further comprises a non-sop additive.

11. The liner of claim 1 further comprises a no-slip additive.

12. The liner of claim 1 comprises a no-slip resin.

13. The liner of claim 1 further comprises a non-slip resin.

14. The liner of claim 1 wherein said liner is comprised of only LLDPE and LDPE.

15. The liner of claim 1 wherein said liner is comprised of LLDPE, LDPE, HDPE or any combination of same.

16. The liner of claim 1 wherein said liner further comprises reprocessed resin.

17. The liner of claim 1 wherein said liner comprises reprocessed resin, no slip resin, non-slip resin, no slip additive, non-slip additive or any combination of same.

18. The liner of claim 1 wherein said liner comprises a material without reprocessed resin to control slip factor or static electricity properties of said liner.

19. The liner of claim 1 wherein said liner is reusable.

20. The liner of claim 1 wherein said liner is washable.

21. The liner of claim 20 wherein said liner is washable in a washing machine.

22. The liner of claim 1 wherein said liner provides protection to objects placed on top of said liner whether used indoors or outdoors.

23. The liner of claim 1 wherein said liner is used in temperatures ranging from approximately −50 degrees Fahrenheit to 150 degrees Fahrenheit, regardless of any wind chill factors.

24. The liner of claim 1 wherein said liner is used in storage units, self-storage units portable storage containers or moving containers, garages, cellars, basements, attics, truck beds, tractor trailer beds, flatbed trucks, recreational vehicles, SUV's, camping grounds and trailer parks.

25. The liner of claim 1 wherein said liner is placed on surfaces such as grass, dirt and sand, or surfaces made from materials such as concrete, polyurethane, tile, wood, stone, straw and glass.

26. The liner of claim 1 further comprising an attachment mechanism for attaching said liner to a surface.

27. The liner of claim 24 wherein said attachment mechanism comprises an adhesive.

28. The liner of claim 1 wherein said liner comprises an attachment mechanism for attaching said liner to grass, dirt or sand surface.

29. The liner of claim 1 further comprising an attachment device, said attachment device comprising a hole where an instrument, such as a stake enters said hole and a surface such as grass dirt or sand holding said liner to said surface.

30. The liner of claim 2 wherein said anti-fungal and anti-microbial agents comprise one or more of copper (II) 8-quinolinolate (CAS No. 10380-28-6); zinc oxide (CAS No. 1314-13-2); zinc-dimethyl dithiocarbamate (CAS No. 137-304); 2-mercaptobenzothiazole, zinc salt (CAS No. 155-04-4); barium metaborate (CAS No. 13701-59-2); tributyl tin benzoate (CAS No. 4342-36-3); bis tributyl tin salicylate (CAS No. 22330-14-9); tributyl tin oxide (CAS No. 56-35-9); parabens: ethyl parahydroxybenzoate (CAS No. 120-47-8); propyl parahydroxybenzoate (CAS No. 94-13-3); methyl parahydroxybenzoate (CAS No. 99-76-3); and butyl parahydroxybenzoate (CAS No. 94-26-8); methylenebis(thiocyanate) (CAS No. 6317-18-6); 1,2-benzisothiazoline-3-one (CAS No. 2634-33-5); 2-mercaptobenzo-thiazole (CAS No. 149-30-4); 5-chloro-2-methyl-3 (2H)-isothiazolone (CAS No. 57373-19-0); 2-methyl-3(2H)-isothiazolone (CAS No. 57373-20-3); zinc 2-pyridinethiol-N-oxide (CAS No. 1346341-7); tetra-hydro-3,5-di-methyl-2H-1,3,5-thiadiazine-2-thione (CAS No. 533-74-4); N-trichloromethyl-thio-4-cyclohexene-1,2-dicarboximide (CAS No. 133-06-2); 2-n-octyl-4-isothiazoline-3-one (CAS No. 26530-20-1); 2,4,5,6-tetrachloro-isophtalonitrile (CAS No. 1897-45-6); 3-iodo-2-propynyl butylcarbamate (CAS No. 55406-53-6); diiodomethyl-p-tolylsulfone (CAS No. 20018-09-1); N-(trichloromethyl-thio)phthalimide (CAS No. 133-07-3); potassium N-hydroxy-methyl-N-methyl-dithiocarbamate (CAS No. 51026-28-9); sodium 2-pyridinethiol-1-oxide (CAS No. 15922-78-8); 2-(thiocyanomethylthio) benzothiazole (CAS No. 21564-17-0); 2-4(-thiazolyl)benzimidazole (CAS No. 148-79-8).

31. The liner of claim 30 wherein said anti-microbial agents and/or anti-fungal agents are mixed with said resins in a suitable concentration and extruded on a blown or cast film extruder.

32. The liner of claim 2 wherein said anti-microbial agents and/or anti-fungal agents are applied to said liner in a suitable concentration after said liner is extruded on a blown or cast film extruder.

33. The liner of claim 1 wherein said liner is flexible, semi-rigid or a rigid plastic liner that is placed on a surface.

34. The liner of claim 1 wherein said liner conforms to said surface upon which it is placed.

35. The liner of claim 1 wherein said liner comprise a blend of plastic resins that include re-processed plastic.

36. The liner of claim 1 wherein said liner has printing on its surface.

37. The liner of claim 1 wherein said liner comprises logos to provide messages including brand reinforcement.

38. The liner of claim 1 wherein said liner has a series of repeating logos printed on said liner.

39. The liner of claim 1 wherein said liner is used as an advertising vehicle to communicate messages, coupons or contests to customers.

40. The liner of claim 1 wherein said liner contains a fragrance.

41. The liner of claim 1 wherein said liner contains an odor-neutralizing agent.

42. The liner of claim 1 wherein said liner is transparent.

43. The liner of claim 1 wherein said liner is translucent.

44. The liner of claim 1 wherein said liner is opaque.

45. The liner of claim 1 wherein said liner comprises color as from tinted resins.
